(19) United States
(12) Patent Application Publication
(10) Pub. No.: US 2026/0201902 A1
(43) Pub. Date: Jul. 16, 2026

(54) ANTI-SWIRL RIBS FOR EROSION RESISTANCE OF ELECTRIC SUBMERSIBLE PUMPS

(71) Applicant: SCHLUMBERGER TECHNOLOGY CORPORATION, Sugar Land, TX (US)

(72) Inventors: Raju EKAMBARAM, Singapore (SG); Teng Fei WANG, Singapore (SG)

(21) Appl. No.: 19/136,308

(22) PCT Filed: Dec. 12, 2023
(86) PCT No.: PCT/US2023/083573

§ 371 Date: Jun. 6, 2025

(30) Foreign Application Priority Data
Dec. 12, 2022 (SG) 10202260414T

(51) Int. Cl. F04D 29/44; F04D 1/08; F04D 13/10; F04D 29/08

(52) U.S. Cl. CPC F04D 29/448; F04D 1/08; F04D 13/10; F04D 29/086; F05D 2240/126

(57) ABSTRACT

Various anti-swirl ribs for improved erosion resistance of electrical submersible pump stages are provided. An electric submersible pump includes a plurality of stages, wherein each stage of the plurality of stages comprises: an impeller; a diffuser comprising a front seal cavity and a front seal area; and one or more ribs formed in or on a front seal cavity.

### CROSS REFERENCE TO RELATED APPLICATIONS

This application claims the benefit of 10202260414T filed Dec. 12, 2022 in Singapore, the entire contents of which are incorporated by reference in their entirety.

### BACKGROUND

### Field

The present disclosure generally relates to electric submersible pumps (ESPs), and more particularly to anti-swirl features for ESPs.

### Description of the Related Art

Various types of artificial lift equipment and methods are available, for example, electric submersible pumps (ESPs). An ESP includes multiple centrifugal pump stages mounted in series, each stage including a rotating impeller and a stationary diffuser mounted on a shaft, which is coupled to a motor. In use, the motor rotates the shaft, which in turn rotates the impellers within the diffusers. Well fluid flows into the lowest stage and passes through the first impeller, which centrifuges the fluid radially outward such that the fluid gains energy in the form of velocity. Upon exiting the impeller, the fluid flows into the associated diffuser, where fluid velocity is converted to pressure. As the fluid moves through the pump stages, the fluid incrementally gains pressure until the fluid has sufficient energy to travel to the well surface.

### SUMMARY

In some configurations, an electric submersible pump includes an impeller, a diffuser having a front seal area, and one or more ribs formed in or on the front seal area. The ribs can define or be defined by undercut areas of the front seal area, the undercut areas recessed radially outwardly into the front seal area.

In some configurations, an electric submersible pump includes an impeller, a diffuser having a front seal cavity at least partially defined by an upwardly facing surface of the diffuser, and one or more partial ribs disposed in the front seal cavity, the partial ribs extending less than an entire radial dimension or length of the front seal cavity. The partial ribs can be formed or disposed on the upwardly facing surface of the diffuser. The partial ribs do not extend across an entire radial dimension of the upwardly facing surface of the diffuser.

In some configurations, an electric submersible pump includes an impeller, a diffuser having an outer wall, and one or more ribs disposed or formed on a radially inner surface of the outer wall of the diffuser. At least a portion of the outer wall of the diffuser may have an increased thickness. The increased thickness area may have a thickness of 0.190″.

### BRIEF DESCRIPTION OF THE FIGURES

Certain embodiments, features, aspects, and advantages of the disclosure will hereafter be described with reference to the accompanying drawings, wherein like reference numerals denote like elements. It should be understood that the accompanying figures illustrate the various implementations described herein and are not meant to limit the scope of various technologies described herein.

FIG. 1 shows a schematic of an electric submersible pump (ESP) system.

FIG. 2 shows a schematic of a plurality of ESP stages.

FIG. 3 shows a longitudinal cross-section of a portion of an ESP showing various areas of erosion.

FIG. 4A shows erosion at the diffuser front seal cavity, front seal, and nesting zone.

FIG. 4B shows erosion at the diffuser front seal cavity, front seal, and nesting zone.

FIG. 5 shows diffuser front seal ribs.

FIG. 6 shows another angle of the 110 diffuser front seal ribs.

FIG. 7 shows erosion at the impeller front seal groove.

FIG. 8 shows full length front seal cavity ribs.

FIG. 9A shows partial or half front seal cavity ribs.

FIG. 9B shows partial or half front seal cavity ribs.

FIG. 10 shows partial or half front seal cavity ribs.

FIG. 11 shows a thick wall diffuser and diffuser wall ID ribs.

FIG. 12 shows a thick wall diffuser and diffuser wall ID ribs.

### DETAILED DESCRIPTION

In the following description, numerous details are set forth to provide an understanding of some embodiments of the present disclosure. It is to be understood that the following disclosure provides many different embodiments, or examples, for implementing different features of various embodiments. Specific examples of components and arrangements are described below to simplify the disclosure. These are, of course, merely examples and are not intended to be limiting. However, it will be understood by those of ordinary skill in the art that the system and/or methodology may be practiced without these details and that numerous variations or modifications from the described embodiments are possible. This description is not to be taken in a limiting sense, but rather made merely for the purpose of describing general principles of the implementations. The scope of the described implementations should be ascertained with reference to the issued claims.

As used herein, the terms “connect”, “connection”, “connected”, “in connection with”, and “connecting” are used to mean “in direct connection with” or “in connection with via one or more elements”; and the term “set” is used to mean “one element” or “more than one element”. Further, the terms “couple”, “coupling”, “coupled”, “coupled together”, and “coupled with” are used to mean “directly coupled together” or “coupled together via one or more elements”. As used herein, the terms “up” and “down”; “upper” and “lower”; “top” and “bottom”; and other like terms indicating relative positions to a given point or element are utilized to more clearly describe some elements. Commonly, these terms relate to a reference point at the surface from which drilling operations are initiated as being the top point and the total depth being the lowest point, wherein the well (e.g., wellbore, borehole) is vertical, horizontal or slanted relative to the surface.

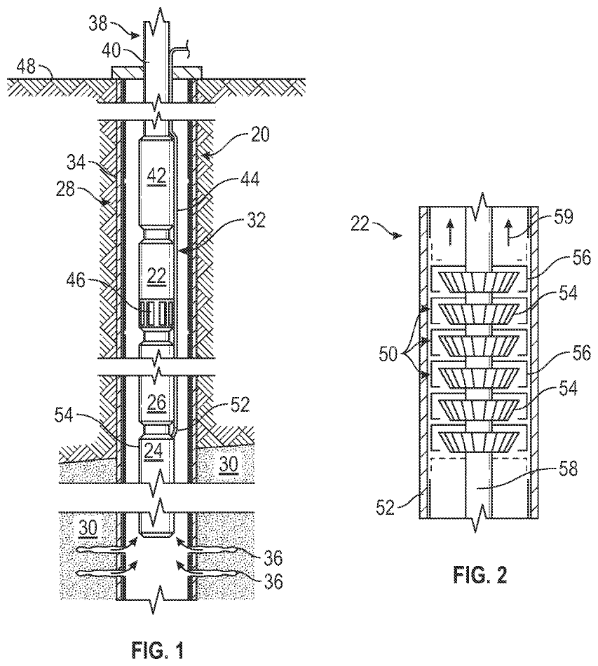

Various types of artificial lift equipment and methods are available, for example, electric submersible pumps (ESP). Electric Submersible Pump (ESP) systems are used in a variety of well applications. ESP systems may comprise centrifugal pumps having a plurality of stages with each stage employing a diffuser and an impeller. FIG. 1 illustrates an example electric submersible pumping system 20. Submersible pumping system 20 may comprise a variety of components depending on the particular application or environment in which it is used. Examples of components utilized in pumping system 20 comprise at least one submersible pump 22, at least one submersible motor 24, and at least one protector 26 coupled together to form the submersible pumping system 20.

In the example illustrated, submersible pumping system 20 is designed for deployment in a well 28 within a geological formation 30 containing desirable production fluids, such as petroleum. A wellbore 32 is drilled into formation 30, and, in at least some applications, is lined with a wellbore casing 34. Perforations 36 are formed through wellbore casing 34 to enable flow of fluids between the surrounding formation 30 and the wellbore 32.

Submersible pumping system 20 is deployed in wellbore 32 by a conveyance system 38 that may have a variety of configurations. For example, conveyance system 38 may comprise tubing 40, such as coiled tubing or production tubing, connected to submersible pump 22 by a connector 42. Power is provided to the at least one submersible motor 24 via a power cable 44. The submersible motor 24, in turn, powers submersible pump 22 which can be used to draw in production fluid through a pump intake 46. In a variety of applications, the submersible pump 22 may comprise a centrifugal pump. Within the submersible centrifugal pump 22, a plurality of impellers is rotated between diffusers to pump or produce the production fluid through, for example, tubing 40 to a desired collection location which may be at a surface 48 of the Earth. As described above, however, components of the pump often suffer deleterious, erosive effects without inclusion of the unique erosion control features described in greater detail below.

It should be noted that many types of electric submersible pumping systems and other types of submersible pumping systems can benefit from the features described herein. Additionally, other components may be added to the pumping system 20, and other deployment systems may be used. Depending on the application, the production fluids may be pumped to the collection location through tubing 40 or through the annulus around deployment system 38. The submersible pump or pumps 22 also may utilize different types of stages, such as mixed flow stages or radial flow stages, having various styles of impellers and diffusers.

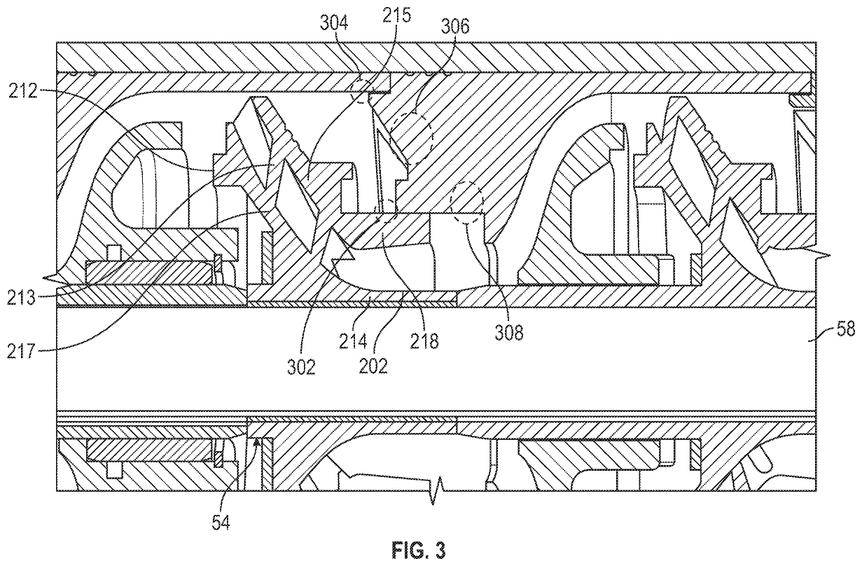

Referring generally to FIG. 2, a portion of an embodiment of submersible pump 22 is illustrated. In this embodiment, the submersible pump 22 is a centrifugal pump comprising at least one stage and often a plurality of stages 50 disposed within an outer pump housing 52. Each stage 50 comprises pump components for inducing and directing fluid flow. As illustrated, the pump components in each stage comprise an impeller 54 and a diffuser 56. Impellers 54 are rotated by a shaft 58 coupled with an appropriate power source, such as submersible motor 24, to pump fluid through centrifugal pump 22 in the direction of arrow 59. As shown in FIG. 3, one or more spacers 202 can be disposed axially between sequential impellers 54.

Each rotating impeller 54 moves fluid from the upstream diffuser 56 into and through the downstream diffuser 56 and into the next sequential impeller 54 until the fluid is expelled from centrifugal pump 22. By way of example, each rotating impeller 54 may discharge fluid to the adjacent downstream diffuser 56 which routes the fluid into a diffuser bowl for receipt by the next sequential impeller 54. The fluid flow is routed through the sequential stages 50 of the submersible centrifugal pump 22 until the fluid is expelled from the submersible pump 22.

FIG. 3 shows some of the key erosion zones. The impeller includes a central hub 214, surrounding a bore through which the shaft 58 extends, and a skirt 218 radially or circumferentially surrounding a portion of the hub 214. A space between (e.g., radially between) the skirt 218 and hub 214 defines an intake or inlet of the impeller 54 and a portion of a flow path through the impeller 54. Impeller blades or vanes 213 extend radially outward from the hub 214. In the illustrated configuration, the impeller 54 includes an upper plate, disc, or shroud 217 and a lower plate, disc, or shroud 215. The upper shroud 217 extends radially outward from the hub 214. In the illustrated configuration, the upper shroud 217 extends at an angle radially outward and upward or downstream from the hub 214. The lower shroud 215 extends radially outward from the skirt 218. In the illustrated configuration, the lower shroud 215 extends at an angle radially outward and upward or downstream from the skirt 218. The impeller blades 213 can extend between (e.g., axially between) the lower 215 and the upper shroud 217. The illustrated impeller 54 can therefore be considered a shrouded impeller. The hub 214, blades 213, lower shroud 215, and upper shroud 217 define fluid flow paths through the impeller 54. As shown, the impeller 54 also includes a balance ring 212 extending upwardly or downstream, e.g., extending longitudinally upwardly or downstream along an axis parallel to a longitudinal axis of the shaft 58, from a top or downstream surface of the upper shroud 217. Swirls may be present at nest area 304. Erosion may also be present at the impeller front seal groove area 302. Swirls may occur at the front seal cavity 306. Swirls may occur at the diffuser front seal area 308.

In oil wells producing substantial amounts of sand, the lifetime of the centrifugal pump may be shortened due to excessive wear. The sand tends to wear on the pumping system components and increases clearances in the case of radial wear. This type of wear can lead to a decrease in the head flow and an increased horsepower demand, thus affecting pump performance. The abrasive sand also can cause holes to develop in diffuser walls and can lead to erosion of pump passages.

Erosive wear often occurs at points where flow discontinuities exist and also in void areas of the diffuser and impeller where sand can get entrapped and circulated. For example, during operation of the ESP system in sandy wells, a small percentage of sand in the production flow falls into the stage front seal cavity area. As the sand becomes trapped in this location, one grain of sand impacts the stage wall multiple times, leading to severe erosion over time. This is especially a concern for pumps operating at high speeds.

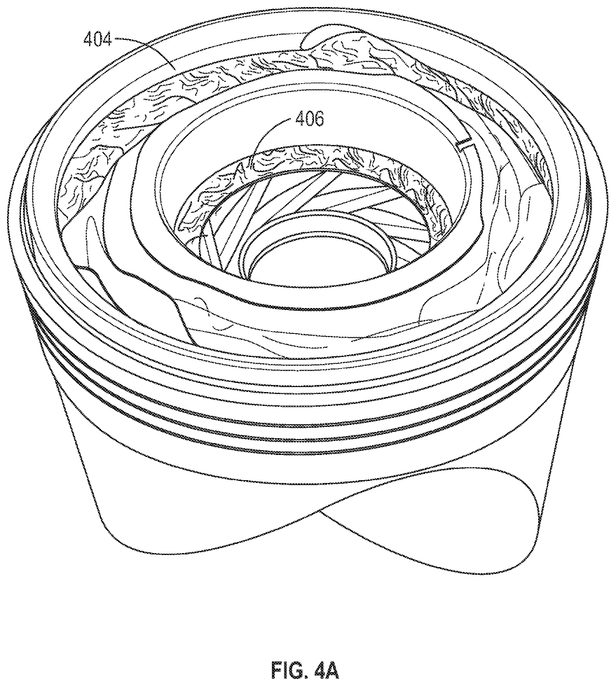

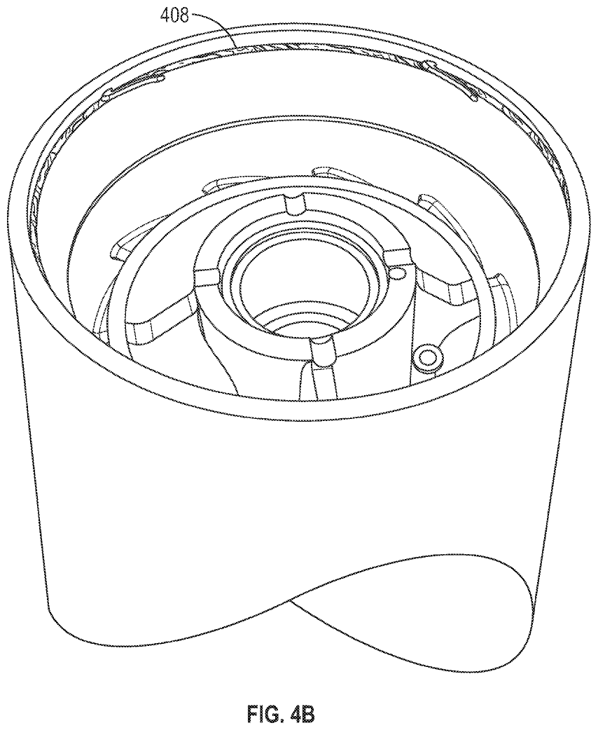

FIGS. 4A-4B illustrate erosion patterns of stages without sand control features as described herein. At FIG. 4A, swirl erosion may be present at the front seal cavity 404 and at the front seal area. At FIG. 4B, swirl erosion may take place adjacent to the nesting zone 408.

The present disclosure generally relates to systems and methodologies for improving sand control in pumps. These techniques may be used in centrifugal pumps by employing rib features and designs to facilitate sand control and thus to reduce erosion from sand in the pumped fluid and prolong ESP run life. Additional details regarding other existing anti-swirl ribs can be found in U.S. Pat. No. 10,738,794 and US Publication No. 2022/0090609, the entirety of each which is hereby incorporated herein by reference.

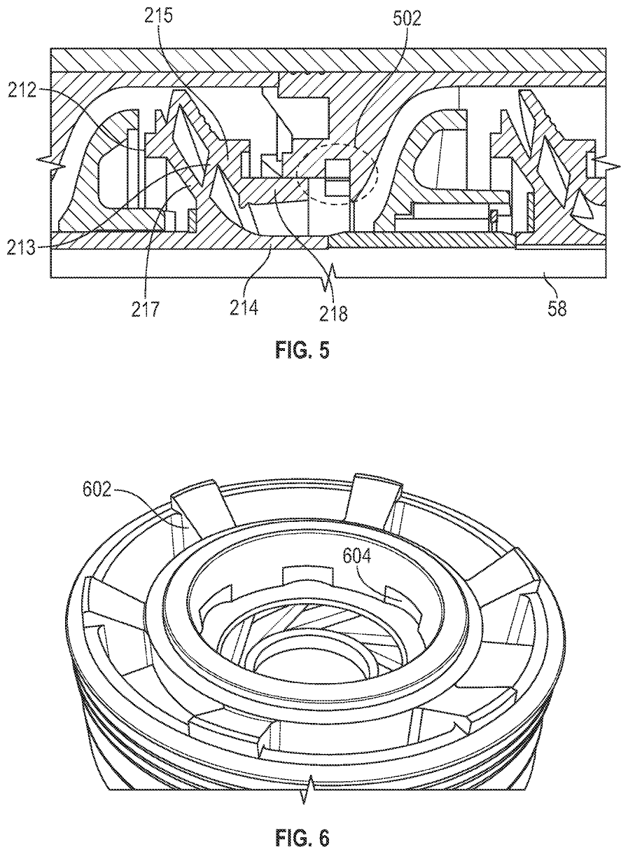

In some configurations, the present disclosure provides one or more ribs at the diffuser front seal to inhibit erosion in the front seal area, as shown in FIGS. 5-6. For example. FIG. 5 shows a rib 502. FIG. 6 shows an anti-swirl rib 602 in the front seal cavity and a front diffuser seal area recession 604 that forms one or more adjacent ribs. As shown in FIG. 3, the diffuser front seal can be a radially inward facing surface of the diffuser that is disposed adjacent, contacts, and/or forms a seal with a radially outer surface of the impeller skirt 218. The diffuser front seal rib can be made via machining, for example using an undercut tool, or directly from casting. Making the rib directly from casting can help reduce machining cost. The diffuser front seal ribs advantageously slow the swirling fluid's flow velocity and deflect sand particle(s) back to the flow passage, thereby reducing erosion at the diffuser front seal.

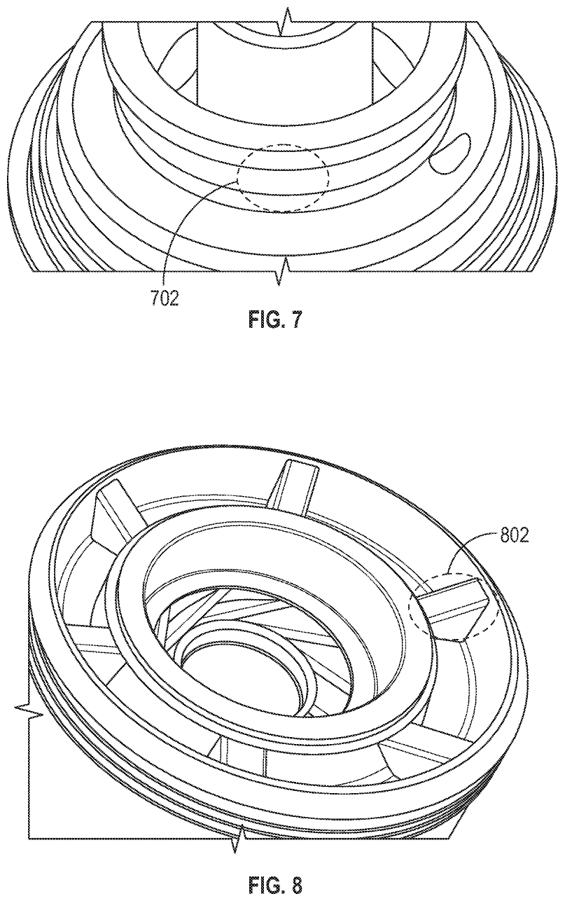

In some configurations and applications, standard-length or full-length front seal cavity ribs may mitigate erosion at the front seal cavity but may increase or worsen erosion at the impeller front seal erosion groove 702, as shown in FIG. 7. This may be caused by some of the sands trapped at the front seal cavity being deflected by the front seal cavity ribs to the impeller front seal ring area, thereby increasing erosion at the impeller front seal ring. Some stages include ribs 802 in the front seal cavity to mitigation erosion at the front seal cavity, as shown in FIG. 8.

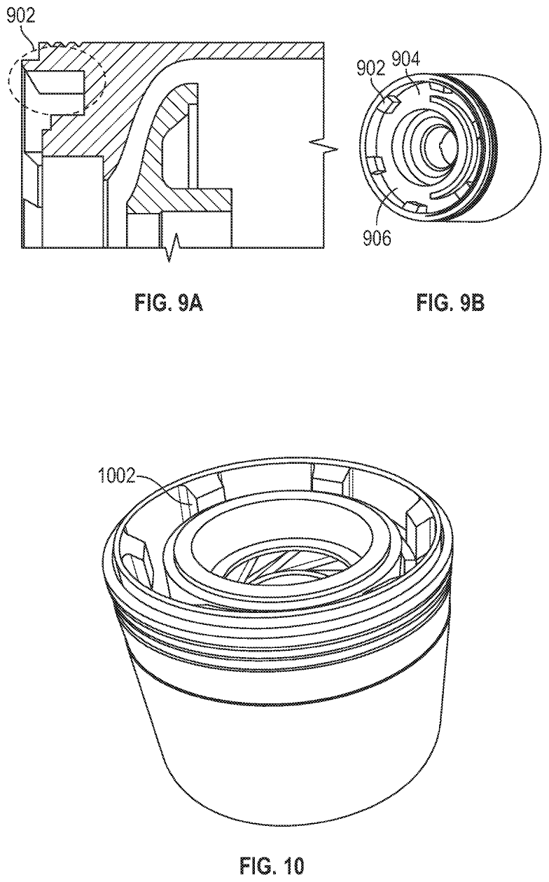

The present application provides a partial rib design for front seal cavity ribs, as shown in FIGS. 9-10. FIG. 9A shows a partial rib 902 in the front seal cavity. FIG. 9B shows the partial rib 902 in the front seal cavity 904 over and/or on the diffuser bowl floor 906. The front seal cavity may be a radially outward facing surface of the diffuser that may be disposed adjacent to the radially inward surface of the nesting zone of the diffuser. As shown, the partial front seal cavity ribs do not extend the full radial dimension or distance of the front seal cavity or diffuser bowl floor. The partial rib design height, width, and/or profile can be designed based on erosion tests or simulations to optimize the design and profile. The partial front seal cavity ribs break or reduce the swirl within the front seal cavity (e.g., at the outer most diameter) and reduce erosion at the diffuser wall ID and nest area. The absence of ribs at the valley area at the inner diameter of the front seal cavity or adjacent to the impeller front seal ring advantageously prevents or inhibits sand deflection at this zone. Therefore, lesser sand will be deflected at the impeller front seal ID, thereby mitigation the groove erosion risks. FIG. 10 shows another angle of the partial rib 1002 (e.g., ⅛ rib, quarter rib, half rib, ¾ rib).

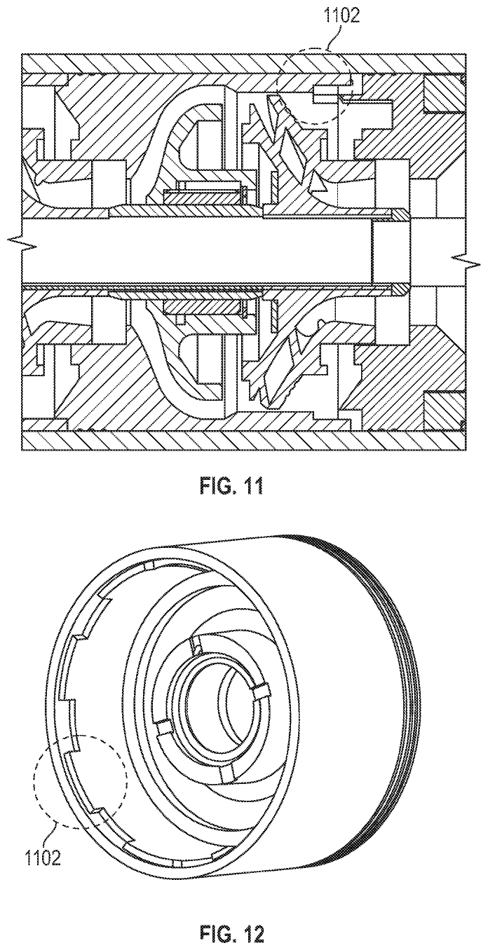

In some configurations, the present disclosure provides a thick wall diffuser with ID ribs, as shown in FIGS. 11-12, to mitigate swirl erosion risks at the diffuser nesting area. The diffuser wall thickness can be increased, for example, from about 0.120″ to about 0.190″. The increased thickness can increase the time and wear needed to erode through the diffuser wall, and therefore prolong the pump run life. Ribs 1102 can be included at the diffuser wall ID near the nest area to slow the swirling flow and deflect sands to the front seal area instead of becoming trapped at the nest area. This can help reduce erosion at the nest area. The diffuser wall ID ribs 1102 can be made directly from casting or by machining. The width, spacing, and/or profile of the ribs can be selected and designed or optimized based on erosion testing.

Language of degree used herein, such as the terms “approximately,” “about,” “generally,” and “substantially” as used herein represent a value, amount, or characteristic close to the stated value, amount, or characteristic that still performs a desired function or achieves a desired result. For example, the terms “approximately,” “about,” “generally,” and “substantially” may refer to an amount that is within less than 10% of, within less than 5% of, within less than 1% of, within less than 0.1% of, and/or within less than 0.01% of the stated amount. As another example, in certain embodiments, the terms “generally parallel” and “substantially parallel” or “generally perpendicular” and “substantially perpendicular” refer to a value, amount, or characteristic that departs from exactly parallel or perpendicular, respectively, by less than or equal to 15 degrees, 10 degrees, 5 degrees, 3 degrees, 1 degree, or 0.1 degree.

Although a few embodiments of the disclosure have been described in detail above, those of ordinary skill in the art will readily appreciate that many modifications are possible without materially departing from the teachings of this disclosure. Accordingly, such modifications are intended to be included within the scope of this disclosure as defined in the claims. It is also contemplated that various combinations or sub-combinations of the specific features and aspects of the embodiments described may be made and still fall within the scope of the disclosure. It should be understood that various features and aspects of the disclosed embodiments can be combined with, or substituted for, one another in order to form varying modes of the embodiments of the disclosure. Thus, it is intended that the scope of the disclosure herein should not be limited by the particular embodiments described above.

What is claimed is:

1. An electric submersible pump comprising:
a shaft coupled to a submersible motor;
a plurality of stages disposed about the shaft and within an outer pump housing, wherein each stage of the plurality of stages induces and directs a flow of a fluid;
each stage of the plurality of stages comprising:
an impeller rotated by the shaft;
a diffuser comprising a front seal cavity and a front seal area;
a diffuser bowl; and
one or more ribs formed in or on a front seal cavity.

2. The pump of claim 1, wherein the one or more ribs formed in or on the front seal cavity partially extend across a radial dimension of the front seal cavity over the diffuser bowl.

3. The pump of claim 1, wherein one or more ribs are formed in or on the front seal area.

4. The pump of claim 3, wherein the one more ribs formed in or on the front seal area are defined by undercut areas of the front seal area, the undercut areas being recessed radially outwardly into the front seal area.

5. The pump of claim 3, wherein the front seal area is a radially inward facing surface of the diffuser that is disposed adjacent to and forms a seal with a radially outer surface of an impeller skirt.

6. The pump of claim 1, wherein one or more spacers are disposed axially between sequential impellers.

7. The pump of claim 1, wherein each impeller induces and directs the flow of the fluid to an adjacent diffuser of an adjacent stage, wherein the adjacent diffuser routes the fluid into an adjacent diffuser bowl for receipt by a subsequent impeller.

8. The pump of claim 1, wherein each impeller comprises:
a central hub surrounding a bore through which the shaft extends;
a skirt radially surrounding a portion of the central hub;
a space radially between the skirt and the central hub defining an intake of each impeller and a portion of the flow of the fluid through each impeller;
a balance ring extending longitudinally upwardly along an axis parallel to a longitudinal axis of the shaft;
impeller blades extending radially outward from the central hub;
an upper plate that extends at an angle radially outward and upward from the central hub;
a lower plate that extends at an angle radially outward and from the skirt,
wherein the impeller blades extend axially between the lower plate and the upper plate, and
wherein the central hub, impeller blades, the lower plate, and the upper plate define a path of the flow of the fluid through each impeller.

9. An electric submersible pump comprising:
an impeller;
a diffuser having a front seal cavity at least partially defined by an upwardly facing surface of the diffuser; and
one or more partial ribs disposed in the front seal cavity, the partial ribs extending less than an entire radial dimension of the front seal cavity.

10. The pump of claim 9, wherein the partial ribs are disposed on the upwardly facing surface of the diffuser.

11. The pump of claim 9, wherein the partial ribs do not extend across an entire radial dimension of the upwardly facing surface of the diffuser.

12. An electric submersible pump comprising:
an impeller;
a diffuser having an outer wall; and
one or more ribs disposed on a radially inner surface of the outer wall of the diffuser.

13. The pump of claim 12, wherein a portion of the outer wall of the diffuser has a thickness of at least 0.190 inches.

14. The pump of claim 1, wherein the one or more ribs formed in or on a front seal cavity are formed directly from casting or by machining.

15. The pump of claim 3, wherein the one more ribs formed in or on the front seal area are formed directly from casting or by machining.

16. The pump of claim 9, wherein the one or more partial ribs disposed in the front seal cavity are formed directly from casting or by machining.

17. The pump of claim 12, wherein the one or more ribs disposed on the radially inner surface of the outer wall of the diffuser are formed directly from casting or by machining.

18. The pump of claim 1, wherein the one or more ribs formed in or on a front seal cavity are configured to reduce a swirl of the fluid within the front seal cavity, by slowing a velocity of the fluid, and reduce erosion at a diffuser wall ID and a nest area by deflecting sand particles back to a flow passage.

19. The pump of claim 3, wherein the one or more ribs formed in or on a front seal area are configured to reduce a swirl of the fluid within the front seal area, by slowing a velocity of the fluid, and reduce erosion at the front seal area by deflecting sand particles back to a flow passage.

20. The pump of claim 12, wherein the one or more ribs disposed on a radially inner surface of the outer wall of the diffuser are configured to reduce a swirl of a fluid at the outer wall, by slowing a velocity of the fluid, and reduce erosion at the outer wall by deflecting sand particles back to a flow passage.
